(19) United States
(12) Patent Application Publication
(10) Pub. No.: US 2020/0106669 A1
(43) Pub. Date: Apr. 2, 2020

(54) COMPUTING NODE CLUSTERS SUPPORTING NETWORK SEGMENTATION

(71) Applicant: Nutanix, Inc., San Jose, CA (US)

(72) Inventors: Jaspal Singh Dhillon, Bengaluru (IN); Simon Mijolovic, Little Falls, NY (US); Sragdhara Datta Chaudhuri, Bangalore (IN)

(73) Assignee: Nutanix, Inc., San Jose, CA (US)

(21) Appl. No.: 16/144,637

(22) Filed: Sep. 27, 2018

(51) Int. Cl. H04L 12/24; G06F 11/14; H04L 29/12; H04L 29/06

(52) U.S. Cl. CPC H04L 41/0816; G06F 11/142; G06F 11/1438; H04L 41/0806; H04L 63/0272; H04L 61/2061; H04L 63/0263; H04L 63/029; H04L 61/2007

(57) ABSTRACT

Examples described herein may include transition of a distributed computing system to using a segmented network configuration. An example method includes receiving a network segmentation request at a distributed computing system. In response to the network segmentation request and during normal operation of the distributed computing system, the method includes allocating IP addresses to computing nodes of the distributed computing system based on a number of segmented networks, and applying firewall rules to open service ports of the computing nodes. Further in response to the network segmentation request and during normal operation, the method includes updating network configuration information of the computing nodes. For a computing node of the computing nodes, the method further includes publishing the allocated IP addresses, and restarting services of the computing node. The method further includes applying the firewall rules to open a subset of the service ports of the computing nodes.

### TECHNICAL FIELD

Examples described herein relate generally to distributed computing systems. Examples of virtualized systems are described. Examples of distributed computing systems described herein may facilitate transition to use of segmented network configurations.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional virtual machine that can run its own operating system, and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a distributed computing system, in accordance with an embodiment of the present disclosure.

FIG. 2 is a block diagram of a distributed computing system utilizing network segmentation, in accordance with an embodiment of the present disclosure.

FIG. 3 is a flowchart of a method for enabling network segmentation at a computing node of a distributed computing system in accordance with some embodiments of the disclosure.

FIG. 4 is a flowchart of a method for setting up a network segmentation interface for a distributed computing system in accordance with some embodiments of the disclosure.

FIGS. 5A-G include example user interface diagrams for setting up a network segmentation interface for a distributed computing system in accordance with some embodiments of the disclosure.

FIG. 6 depicts a block diagram of components of a computing node in accordance with an embodiment of the present disclosure.

### DETAILED DESCRIPTION

This disclosure describes embodiments for transition to network segmentation in a distributed computing system. Network segmentation typically involves isolating certain classes of traffic from other classes of traffic. For example, management traffic (e.g., traffic transmitted to and received from sources outside the distributed computing system) may be segmented into a different network than backplane traffic (e.g., traffic contained within the distributed computing system). Segmentation of traffic may be desirable for security purposes and/or for purposes of predicting and managing network bandwidth usage. In some examples, the transition to segmented networks may be responsive to a received request for segmentation. The request may include one or more network interface definitions. Each network interface definition defines the associated class of traffic, and other parameters for setting up the network interface. A network manager on the computing nodes of the distributed computing system may be configured to manage transition to segmented networks. In some examples, the transition may be performed by the distributed computing system while the distributed system remains operational. This type of transition may employ a rolling update, where the computing nodes of the distributed computing system are updated in a sequential and ordered fashion. That is, during the rolling update, only one computing node is updated at a time, allowing the other computing nodes to remain operational during the update. To facilitate the network segmentation transition, firewall rules may be relaxed on open service ports on the computing nodes to allow communication within the system. The firewall rules may be reinstated after the update to provide protection against undesired traffic.

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

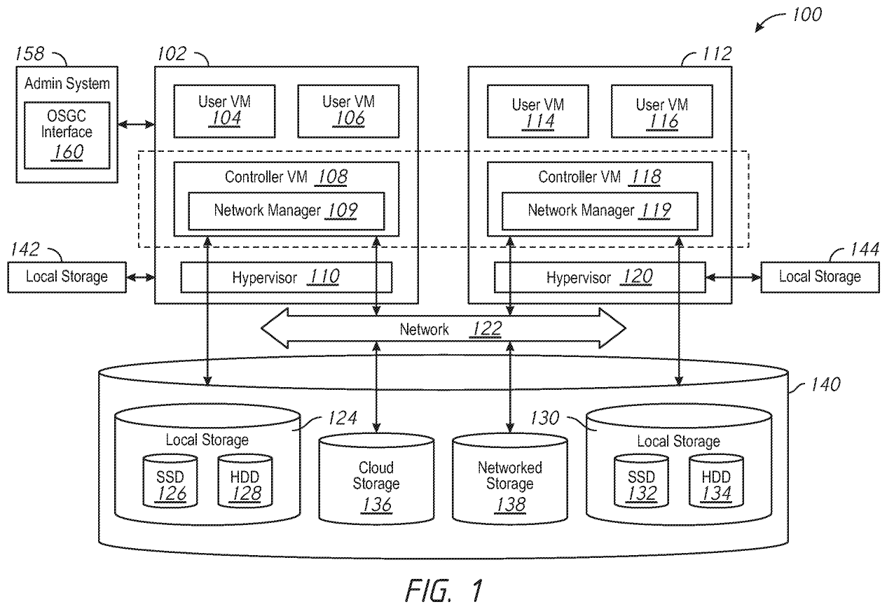

FIG. 1 is a block diagram of a distributed computing system 100, in accordance with an embodiment of the present disclosure. The distributed computing system 100 generally includes a computing node 102 and a computing node 112 and storage 140 connected to a network 122. The network 122 may be any type of network capable of routing data transmissions from one network device (e.g., the computing node 102, the computing node 112, and the storage 140) to another. For example, the network 122 may be a local area network (LAN), wide area network (WAN), intranet, Internet, or a combination thereof. The network 122 may be a wired network, a wireless network, or a combination thereof.

The storage 140 may include local storage 124, local storage 130, cloud storage 136, and networked storage 138. The local storage 124 may include, for example, one or more solid state drives (SSD 126) and one or more hard disk drives (HDD 128). Similarly, the local storage 130 may include SSD 132 and HDD 134. The local storage 124 and the local storage 130 may be directly coupled to, included in, and/or accessible by a respective the computing node 102 and/or the computing node 112 without communicating via the network 122. Other nodes, however, may access the local storage 124 and/or the local storage 130 using the network 122. Cloud storage 136 may include one or more storage servers that may be stored remotely to the computing node 102 and/or the computing node 112 and accessed via the network 122. The cloud storage 136 may generally include any suitable type of storage device, such as HDDs SSDs, or optical drives. Networked storage 138 may include one or more storage devices coupled to and accessed via the network 122. The networked storage 138 may generally include any suitable type of storage device, such as HDDs SSDs, and/or NVM Express (NVMe). In various embodiments, the networked storage 138 may be a storage area network (SAN). The computing node 102 is a computing device for hosting virtual machines (VMs) in the distributed computing system 100.

The computing node 102 may be configured to execute a hypervisor 110, a controller VM 108 and one or more user VMs, such as user VMs 104, 106. The user VMs including the user VM 104 and the user VM 106 are virtual machine instances executing on the computing node 102. The user VMs including the user VM 104 and the user VM 106 may share a virtualized pool of physical computing resources such as physical processors and storage (e.g., the storage 140). The user VMs including the user VM 104 and the user VM 106 may each have their own operating system, such as Windows or Linux. While a certain number of user VMs are shown, generally any suitable number may be implemented. User VMs may generally be provided to execute any number of applications which may be desired by a user.

The hypervisor 110 may be any type of hypervisor. For example, the hypervisor 110 may be ESX, ESX(i), Hyper-V, KVM, or any other type of hypervisor. The hypervisor 110 manages the allocation of physical resources (such as the storage 140 and physical processors) to VMs (e.g., user VM 104, user VM 106, and controller VM 108) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 108 and/or the controller VM 118, may provide services for the user VMs in the computing node. As an example of functionality that a controller VM may provide, the controller VM 108 may provide virtualization of the storage 140. Accordingly, the storage 140 may be referred to as a storage pool. Controller VMs may provide management of the distributed computing system 100. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging PCI Pass-through in some examples. In this manner, controller VMs described herein may manage input/output (I/O) requests between VMs on a computing node and available storage, such as the storage 140.

The computing node 112 may include user VM 114, user VM 116, a controller VM 118, and a hypervisor 120. The user VM 114, the user VM 116, the controller VM 118, and the hypervisor 120 may be implemented similarly to analogous components described above with respect to the computing node 102. For example, the user VM 114 and the user VM 116 may be implemented as described above with respect to the user VM 104 and the user VM 106. The controller VM 118 may be implemented as described above with respect to the controller VM 108. The hypervisor 120 may be implemented as described above with respect to the hypervisor 110. In some examples, the hypervisor 120 may be a different type of hypervisor than the hypervisor 110, example, the hypervisor 120 may be Hyper-V, while the hypervisor 110 may be ESX(i). In some examples, the hypervisor 110 may be of a same type as the hypervisor 120.

The controller VM 108 and the controller VM 118 may communicate with one another via the network 122. By linking the controller VM 108 and the controller VM 118 together via the network 122, a distributed network of computing nodes including the computing node 102 and the computing node 112, can be created.

Controller VMs, such as the controller VM 108 and the controller VM 118, may each execute a variety of services and may coordinate, for example, through communication over network 122. Services running on controller VMs may utilize an amount of local memory to support their operations. For example, services running on the controller VM 108 may utilize memory in local memory 142. Services running on the controller VM 118 may utilize memory in local memory 144. The local memory 142 and the local memory 144 may be shared by VMs on the computing node 102 and the computing node 112, respectively, and the use of the local memory 142 and/or the local memory 144 may be controlled by the hypervisor 110 and the hypervisor 120, respectively. The local memory 142 and 144 may include a flash driver or some other removable form of memory installed on the computing node 102 and 112, respectively. Moreover, multiple instances of the same service may be running throughout the distributed system—e.g. a same services stack may be operating on each controller VM. For example, an instance of a service may be running on the controller VM 108 and a second instance of the service may be running on the controller VM 118.

Generally, controller VMs described herein, such as the controller VM 108 and the controller VM 118 may be employed to control and manage any type of storage device, including all those shown in the storage 140, including the local storage 124 (e.g., SSD 126 and HDD 128), the cloud storage 136, and the networked storage 138. Controller VMs described herein may implement storage controller logic and may virtualize all storage hardware as one global resource pool (e.g., the storage 140) that may provide reliability, availability, and performance. IP-based requests are generally used (e.g., by user VMs described herein) to send I/O requests to the controller VMs. For example, user VM 104 and user VM 106 may send storage requests to the controller VM 108 using over a virtual bus. Controller VMs described herein, such as the controller VM 108, may directly implement storage and I/O optimizations within the direct data access path. Communication between hypervisors and controller VMs described herein may occur using IP requests.

Note that controller VMs are provided as virtual machines utilizing hypervisors described herein—for example, the controller VM 108 is provided behind hypervisor 110. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in the storage 140, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 108 may expose one or more vDisks of the storage 140 and the hypervisor may attach the vDisks to one or more VMs, and the virtualized operating system may mount a vDisk on one or more user VMs, such as the user VM 104 and/or the user VM 106.

During operation, the user VMs (e.g., the user VM 104 and/or the user VM 106) may provide storage input/output (I/O) requests to controller VMs (e.g., the controller VM 108 and/or the hypervisor 110). Accordingly, a user VM may provide an I/O request over a virtual bus to a hypervisor as an iSCSI and/or NFS request. Internet Small Computer system Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File system (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, examples of user VMs described herein may provide storage requests using an IP based protocol, such as SMB. The storage requests may designate the IP address for a controller VM from which the user VM desires I/O services. The storage request may be provided from the user VM to a virtual switch within a hypervisor to be routed to the correct destination. For examples, the user VM 104 may provide a storage request to hypervisor 110. The storage request may request I/O services from controller VM 108 and/or the controller VM 118. If the request is to be intended to be handled by a controller VM in a same service node as the user VM (e.g., the controller VM 108 in the same computing node as the user VM 104) then the storage request may be internally routed within the computing node 102 to the controller VM 108. In some examples, the storage request may be directed to a controller VM on another computing node. Accordingly, the hypervisor (e.g., the hypervisor 110) may provide the storage request to a physical switch to be sent over a network (e.g., the network 122) to another computing node running the requested controller VM (e.g., the computing node 112 running the controller VM 118).

Accordingly, hypervisors described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

In some examples, the distributed computing system 100 may support network segmentation. That is, network traffic may be segmented to isolate different classes of traffic. For example, management traffic (e.g., traffic transmitted to and received from sources outside the distributed computing system 100) may be segmented into a different network than backplane traffic (e.g., traffic contained within the distributed computing system 100). Examples of management traffic may include traffic to and from computing devices or nodes over outside networks, such as WANs or the Internet (e.g., using secure shell (SSH), simple network management protocol SNMP, etc.). Management traffic may be transmitted by or received by the user VMs 104, 106, 114, 116, the controller VMs, 108, 118, the hypervisors 110, 120. The backplane traffic may include traffic for operation within the distributed system 100, such as configuration changes, data storage, management of the distributed computing system 100, etc. The backplane traffic may be primarily transmitted by or received by the controller VMs 108, 118. Network segmentation may be desirable for security purposes and/or for purposes of predicting and managing network bandwidth usage. For example, internal backplane traffic may be isolated from outside management traffic, which may prevent an outside actor from interfering with internal operation of the distributed computing system 100. The network segmentation may be segmented differently and may include more than two segmentations without departing from the scope of the disclosure.

To support network segmentation, the controller VM 108 may include a network manager 109 and the controller VM 118 may include a network manager 119. The network manager 109 and the network manager 119 are each configured to control/manage the network segmentation. For example, the network manager 109 and the network manager 119 may each receive a request and instructions for a network segmentation implementation, and may provision additional networks, provision network interface cards (NICs), retrieve assigned internet protocol (IP) addresses, look up assigned IP addresses for other components, and perform other operations associated with conversion to segmented networks. In some examples, the provisioned networks may include virtual networks, and provision of the NICs may include creation of virtual NICs for each individual network. That is, the communication through the network 122 may use the same physical hardware/conduit, with the segmentation of traffic achieved by addressing traffic to different vLAN identifiers (e.g., each associated with a different virtual NIC (vNIC) configured for each controller VM 108, 118 for each class of network traffic).

Enabling/disabling network segmentation may be controlled by an administration system. For example, as shown in FIG. 1, the distributed computing system 100 may include or be connected to an administrator system 158 that is configured to control network segmentation on the distributed computing system 100. The administrator system 158 may be implemented using, for example, one or more computers, servers, laptops, desktops, tablets, mobile phones, or other computing systems. In other examples, the administrator system 158 may be wholly and/or partially implemented using one of the computing nodes of the distributed computing system 100. However, in some examples, the administrator system 158 may be a different computing system from the distributed computing system 100 and may be in communication with one or more controller VMs 108, 118 of the distributed computing system 100 using a wired or wireless connection (e.g., over a network).

The administrator system 158 may host one or more user interfaces, e.g., user interface 160. The user interface 160 may be implemented, for example, by displaying a user interface on a display of the administrator system. The user interface 160 may receive input from one or more users (e.g., administrators) using one or more input device(s) of the administrator system, such as, but not limited to, a keyboard, mouse, touchscreen, and/or voice input. The user interface 160 may provide input to the controller VM(s) 108, 118 and/or may receive data from the controller VM(s) 108, 118. The user interface 160 may be implemented, for example, using a web service provided by the controller VM 108 or one or more other controller VMs described herein. In some examples, the user interface 160 may be implemented using a web service provided by the controller VM 108 and information from the controller VM 108 may be provided to the administrator system 158 for display in the user interface 160.

In some examples, a user may interact with the user interface 160 of the administrator system 158 to set up particular network segmentation configurations on the distributed computing system 100. In some examples, the user may create new networks interfaces, assign classifications of traffic to the new network interface, assign network parameters, such as firewall rules, subnets, network masks, virtual networks identifiers, address pools and ranges, service port numbers, etc. Based on the network parameter inputs, in some examples, software running on the administrator system 158 may assign IP addresses to the computing nodes 102 and 112 for each segmented network interface definition. In other examples, the IP addresses may be assigned by the distributed computing system 100 after receiving a request. The administrator system 158 may provide a network segmentation request, including the network segmentation configuration information, to the controller VM(s) 108, 118. In some examples, the network segmentation configuration information may be provided to a selected one of the controller VMs 108 or 118 and the selected one of the controller VMs 108, 118 may provide the network segmentation configuration information to the other of the controller VMs 108, 118. The network managers 109, 119 may be configured to set up hypervisor backplane interfaces for each segmented network to implement assigned network configurations for each segmented network.

In some examples, the network segmentation may be provisioned at the time of initial setup/installation of the distributed computing system 100. In other examples, the network segmentation may be implemented while the distributed computing system 100 is operational (e.g., in normal operation), example, the administrator system 158 may provide instructions to the controller VMs 108, 118 to enable network segmentation while the distributed computing system 100 remains in a normal operating mode. That is, the distributed computing system 100 may transition to a segmented network implementation without disruption of operation of the distributed computing system 100 (e.g., the transition may be transparent to the user VMs 104, 106 and 114, 116 and other applications and services running on the computing nodes 101 and 112, respectively, such that they continue to communicate and operate with minimal or no disruption). This may be more efficient than a network segmentation implementation that involves disruption (e.g., stopping, restarting, reconfiguring, etc.) of normal operation of the user VMs 104, 106 and 114, 116 and other applications and services running on the computing nodes 101 and 112, respectively, to implement the segmentation (e.g., non-normal operation. The distributed computing system 100 may utilize a rolling update where the computing nodes 102 and 112 are updated using an iterative update process. That is, the network managers 109, 119 may implement a rolling process that includes opening of service ports on each segmented network, updating IP address mapping in a database, strategic publishing of IP address assignment information, converting the computing nodes 102, 112 to segmented network operation sequentially, etc. Publishing of the network segmentation information may be via a distributed database. Thus, during the rolling process, one computing node (e.g., the computing node 102) may be configured to receive traffic according to the defined segmented network configuration while other computing nodes (e.g., the computing node 112) may remain configured for the non-segmentation network setup. To facilitate the network segmentation in order to relax communication restriction within the distributed computing system 100.

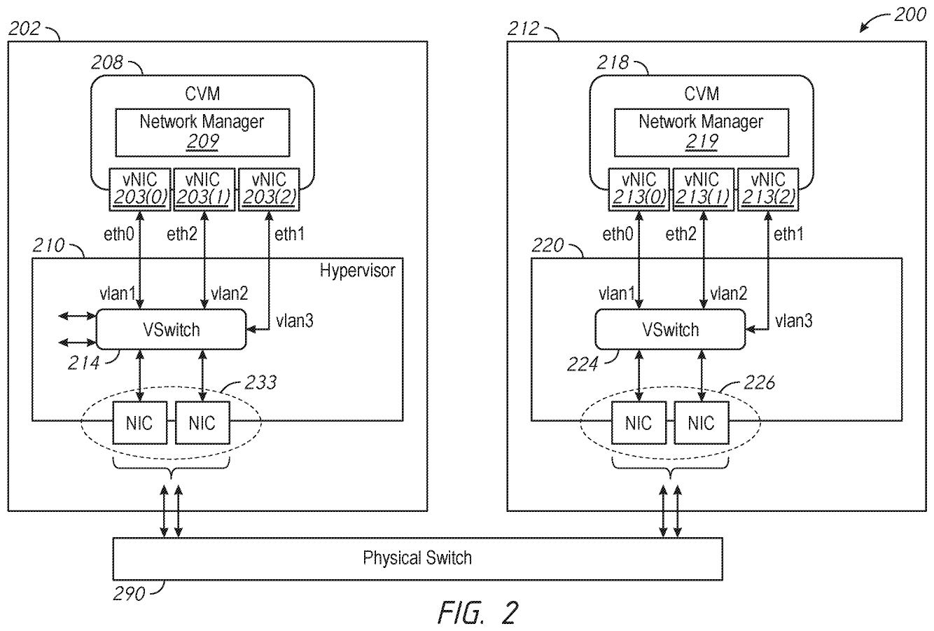

FIG. 2 is a block diagram of a distributed computing system 200 utilizing network segmentation, in accordance with an embodiment of the present disclosure. The distributed computing system 200 generally includes a computing node 202, a computing node 212, and a switch 290. The distributed computing system 100 of FIG. 1 may implement the distributed computing system 200, in some examples. The computing nodes 202 and 212 may communicate using the switch 290 over one or more segmented networks. The one or more networks may include any type of network capable of routing data transmissions from one network device (e.g., the computing node 202, the computing node 212, and the switch 290) to another. The network may include a local area network (LAN), wide area network (WAN), intranet, Internet, or a combination thereof. The network include a wired network, a wireless network, or a combination thereof. In some examples, the networks may be virtual networks, such as virtual LANs (VLANs)

The computing node 202 may be configured to execute a hypervisor 210, a controller VM 208 and one or more user VMs (not shown). The hypervisor 210 may be any type of hypervisor. For example, the hypervisor 210 may be ESX, ESX(i), Hyper-V, KVM, or any other type of hypervisor. The hypervisor 210 manages the allocation of physical resources (such as storage and physical processors) to VMs (e.g., user VMs and the controller VM 208) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

The computing node 212 may include user VMs (not shown), a controller VM 218, and a hypervisor 220. The controller VM 218 may be implemented as described above with respect to the controller VM 208. The hypervisor 220 may be implemented as described above with respect to the hypervisor 210. In some examples, the hypervisor 220 may be a different type of hypervisor than the hypervisor 210. For example, the hypervisor 220 may be Hyper-V, while the hypervisor 210 may be ESX(i). In some examples, the hypervisor 210 may be of a same type as the hypervisor 220.

Controller VMs (CVMs) described herein, such as the controller VM 208 and/or the controller VM 218, may provide services for the user VMs in the computing node. As an example of functionality that a controller VM may provide, the controller VM 208 may provide virtualization of storage (e.g., the storage 140 of FIG. 1). Controller VMs may provide management of the distributed computing system 200. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging PCI Pass-through in some examples. In this manner, controller VMs described herein may manage input/output (I/O) requests between VMs on a computing node and available storage.

The controller VM 208 and the controller VM 218 may communicate with one another using one or more segmented networks via the physical switch 290. By linking the controller VM 208 and the controller VM 218 together via the one or more segmented networks, a distributed network of computing nodes including the computing node 202 and the computing node 212, can be created.

Controller VMs, such as the controller VM 208 and the controller VM 218, may each execute a variety of services and may coordinate, for example, through communication over one or more segmented networks. Services running on controller VMs may utilize an amount of local memory to support their operations. Moreover, multiple instances of the same service may be running throughout the distributed system 200—e.g. a same services stack may be operating on each controller VM. For example, an instance of a service may be running on the controller VM 208 and a second instance of the service may be running on the controller VM 218.

Note that controller VMs are provided as virtual machines utilizing hypervisors described herein—for example, the controller VM 208 is provided behind hypervisor 210. Since the controller VMs run “above” the hypervisors examples described herein may be implemented within any virtual machine architecture, since the controller VMs may be used in conjunction with generally any hypervisor from any virtualization vendor.

During operation, user VMs operating on the computing nodes 202, 212 of the distributed file system 200 may provide I/O requests to the controller VMs 208, 218 and/or the hypervisors 210, 220 using one or more of the segmented networks. Hypervisors described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

As previously described, the distributed computing system 200 may support network segmentation for operational and security benefits. Without network segmentation, all external (e.g., outside of the distributed computing system 200) and internal traffic (e.g., within the distributed computing system 200) would be shared over a single network, which could expose the distributed computing system 200 to security risks. Network segmentation may also be desirable for purposes of predicting and managing network bandwidth usage. In the example of FIG. 2, the distributed computing system 200 may utilize a first network interface ETH0 (e.g., having a first VLAN VLAN1) for a first class of traffic, a second network interface ETH2 (e.g., having second VLAN VLAN2) for a second class of traffic, and a third network interface ETH1 (e.g., having a third VLAN VLAN3) for a third class of traffic. In one example, backplane traffic may be allocated to the VLAN1, management traffic may be allocated to the VLAN2, and intra-computing node traffic may be allocated to VLAN3. To support network segmentation, the controller VMs 208, 218 may each include a respective network manager 209, 219. The network managers 209, 219 may configure the respective controller VM 208, 218 for network segmentation. For example, the network managers 209, 219 may create vNICs for each of the ETH0, ETH2, and ETH1 network interfaces, and assign a specified IP address to each vNIC. The network manager 209 may create vNICs 203(0)-(2), for communication using ETH0 (vLAN1), ETH2 (vLAN2), and ETH1 (vLAN3), respectively. Each of the ETH0 (vLAN1), ETH2 (vLAN2), and ETH1 (vLAN3), respectively, may act as a respective vNIC(0)-(2).

The hypervisors 210, 220 may include respective virtual switches vswitches 214 and 224, and multiple NICs 233 and 226, respectively. The multiple NICs 233 and 226 may include physical NICs, such as peripheral component interconnect (PCI) NICs (pNICs). While only two NICs 233 and 226 are shown, more NICs may be included without departing from the scope of the disclosure. The vswitches 214 and 224 may be configured to route traffic for associated with each of the vLAN1, vLAN2, and vLAN3. The vswitch 214 may be configured to route data/traffic between the vNICs 203(0)-(2) and the NICs 233. The vswitch 224 may be configured to route data/traffic between the vNICs 213(0)-(2) and the NICs 226. The routing by the vswitches 214, 224 may be based on network identifiers, IP addresses, etc. The NICs 233 and 226 may be coupled to the switch 290 to transmit and receive traffic/data. For example, internal backplane traffic may be isolated from outside management traffic, which may prevent an outside actor from interfering with internal operation of the distributed computing system 200. The network segmentation may be segmented differently and may include more than two segmentations without departing from the scope of the disclosure.

As previously described, the network manager 209 and the network manager 219 are each configured to control/manage the network segmentation. The network managers 209, 219 may receive a request and instructions for a network segmentation implementation, and may provision the ETH0, ETH2, and ETH1 network interfaces (e.g., the vNICs 203(0)-(2), 213(0-(2))), retrieve assigned internet protocol (IP) addresses, look up assigned IP addresses for other components. In some examples, the network segmentation may be implemented at the time of installation/setup of the distributed computing system 200. In other examples, the network segmentation may be triggered while the distributed computing system 200 is operational.

Enabling/disabling network segmentation within the distributed computing system 200 may be controlled by an administrator system, such as the administrator system 158 of FIG. 1. The administrator system may provide a request to initiate network segmentation, along with network segmentation configuration information, to the network managers 209, 219. The network segmentation configuration information may include a network interface definition and network segmentation parameters, such as firewall rules, subnets, network masks, virtual networks identifiers, IP address pools and ranges, service port numbers, assigned IP addresses, etc. In some examples, the network segmentation configuration information may be provided to a selected one of the network managers 209, 219/controller VMs 208 or 218 and the selected one of the network managers 209, 219/controller VMs 208, 218 may provide the network segmentation configuration information to the other of network managers 209, 219/the controller VMs 208, 218. The network managers 209, 219 may be configured to set up host interfaces for each segmented network to implement assigned network configurations for each segmented network.

In some examples, the network segmentation may be provisioned at the time of initial setup/installation of the distributed computing system 200. In other examples, the network segmentation may be implemented while the distributed computing system 200 is operational. In some examples, the network managers 209, 219 may initiate a rolling update process to enable network segmentation while the distributed computing system 200 remains operational in response to a network segmentation request. The rolling update process may include applying firewall rules to open of service ports on two or more of the ETH2, and ETH1 network interfaces, updating IP address mapping in a database, strategic publishing of IP address assignment information, and sequentially restarting the controller VMs 208, 218 on each node, etc. Thus, during the rolling process, one computing node (e.g., the computing node 202) may be configured to receive traffic according to the defined segmented network configuration while other computing nodes (e.g., the computing node 212) may remain configured for the non-segmentation network setup. Upon restart, each of the controller VMs 208, 218 may publish a remote procedure call (RPC) handler to identify communication information for the controller VM 208, 218. To facilitate the update and prevent communication blockage, firewall rules may be relaxed on open service ports on the distributed computing system 200. The firewall rules may be reinstated after the update to provide protection against undesired traffic.

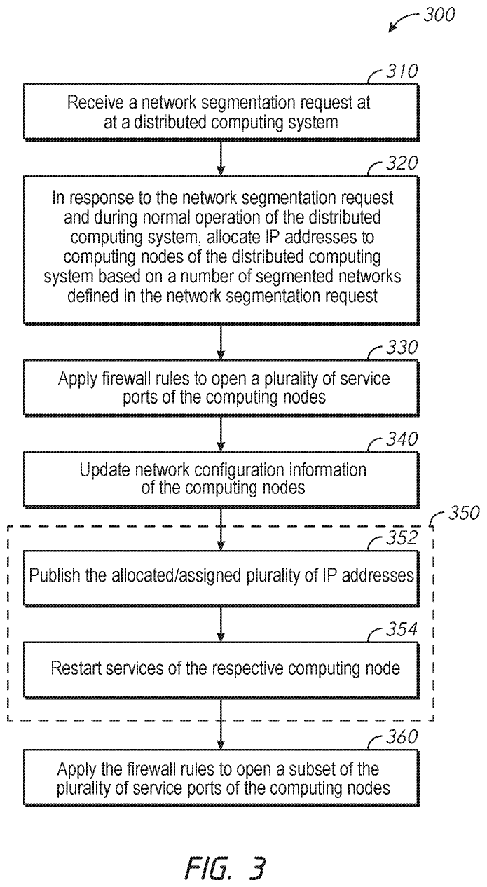

FIG. 3 is a flowchart of a method 300 for enabling network segmentation at a computing node of a distributed computing system in accordance with some embodiments of the disclosure. The method 300 may be performed by the distributed computing system 100 of FIG. 1, the distributed computing system 200 of FIG. 2, or combinations thereof. In a specific example, one or more network managers, such as the network managers 109, 119 of FIG. 1, the network managers 209, 219 of FIG. 2, or combinations thereof may implement the method 300. During performance of the method 300, the distributed computing system may remain operational. That is, the transition to network segmentation may be transparent to a user.

The method 300 may include receiving a network segmentation request, at 310. The network segmentation request may be received from an administrator system, such as the administrator system 158 of FIG. 1. The network segmentation request may include network segmentation configuration information. The network segmentation configuration information may include a request to assign a first class of data traffic to a first network interface and a request to assign a second class of data traffic to a second network interface, for example. Additional requests may be included without departing from the scope of the disclosure. Each network interface definition may include parameters pertaining to one or more of firewall rules, subnets, network masks, virtual networks identifiers, IP address pools and ranges, service port numbers, assigned IP addresses, etc.

In response to the network segmentation request and during normal operation of the distributed computing system, the method 300 may include performance of one or all of the steps 320-370. That is, the transition may be transparent to the user VMs and other applications and services running on the computing nodes of the distributed computing system such that they continue to communicate and operate with minimal or no disruption (e.g., remain in a normal operating mode). For example, the method 300 may further include, allocating and assigning a plurality of internet protocol (IP) addresses to computing nodes of the distributed computing system based on a number of segmented networks defined in the network segmentation request, at 320. If the number of segmented networks is set to two, then two IP addresses would be allocated and assigned. The assigned IP addresses for each node may be included in a database on the distributed computing system.

The method 300 may further include applying firewall rules to open a plurality of service ports of the computing nodes, at 330. The service ports may be opened for one or both of the segmented networks defined in the request, such as opening ports for one or more of the vLAN1, vLAN2, or vLAN3 of FIG. 2. Application of the firewall rules may prevent communication blockage within the distributed computing system during the transition to network segmentation. The firewall rules may be dynamic for each service port type based on the current network state of the distributed computing system, the application in which the distributed computing system is being used, etc.

The method 300 may further include updating network configuration information of the computing nodes, at 340. Updating the network configuration information may include updating a configuration for a particular class of traffic to specify a new subnet, network mask, and vLAN identifier for the particular class of traffic.

The method 300 may further include performing a rolling update of the computing nodes, at 350. That is, the rolling update may include an update a first computing node of the distributed computing system, followed by updating a second computing node of the distributed computing system For each computing node, the rolling update may include publishing the allocated and assigned plurality of IP address, at 352, and restarting services of the computing node, at 354. Publishing the IP addresses may be to a service that stores currently assigned IP addresses. Publishing of the IP addresses may include updating of distributed database that maintains a list of current IP addresses. After publishing of the new IP address for a particular subnet, services that monitor current IP addresses to update communication. Restarting services may include restarting services running on the controller VM (e.g., any of the controller VMs 108, 118 of FIG. 1 or the controller VMs 208, 218 of FIG. 2). The restart may include stopping of running services, updating IP addresses to newly assigned IP addresses, and rebooting the controller VM. Upon reboot, the controller VM may publish a remote procedure call (RPC) handler to identify communication information for the controller VM. Once all computing nodes have transitioned to the network segmentation, one or more of the computing nodes of the distributed computing system may provide confirmation of completion to an administrator system, for example.

After the rolling update has been completed on each of the computing nodes, the method 300 may further include applying the firewall rules to open a subset of the plurality of service ports of the computing node, at 360. For example, the method may include applying firewall rules to only open service ports for one of the segmented networks, such as a segmented network associated with the backplane traffic.

The method 300 is exemplary. The method 300 may include fewer or additional steps for each transition to network segmentation departing from the scope of the disclosure.

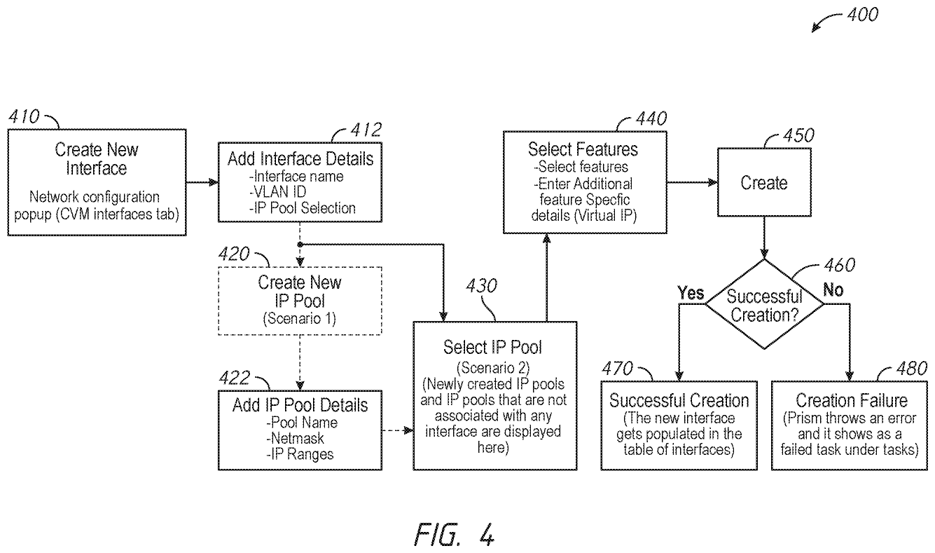

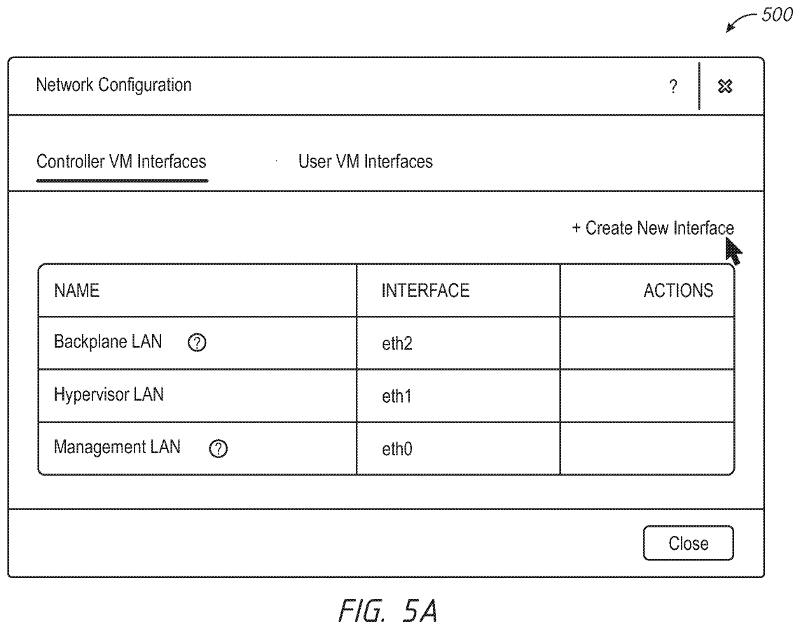

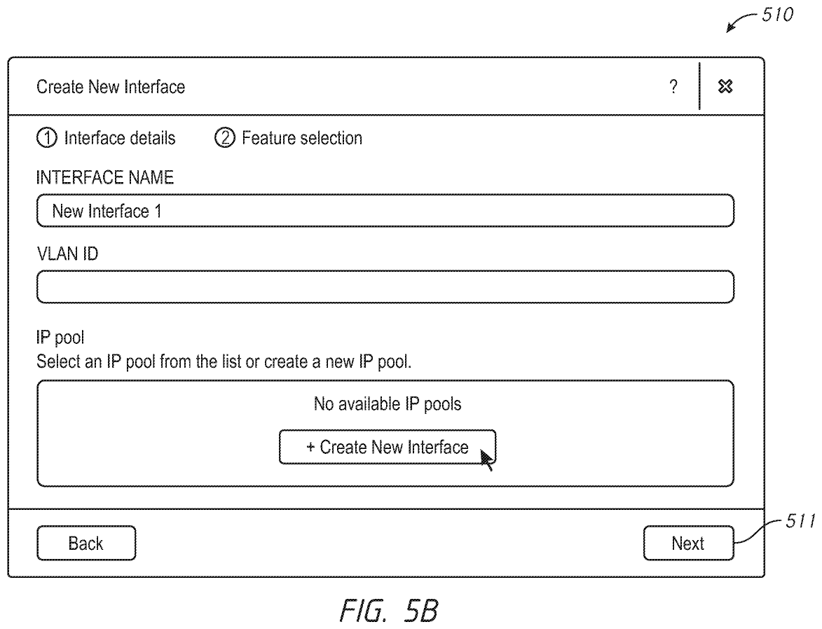

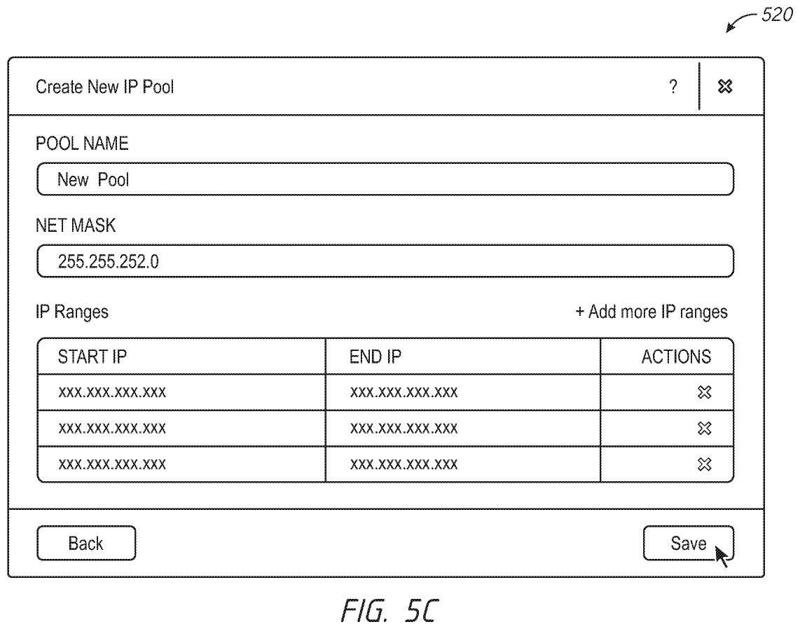

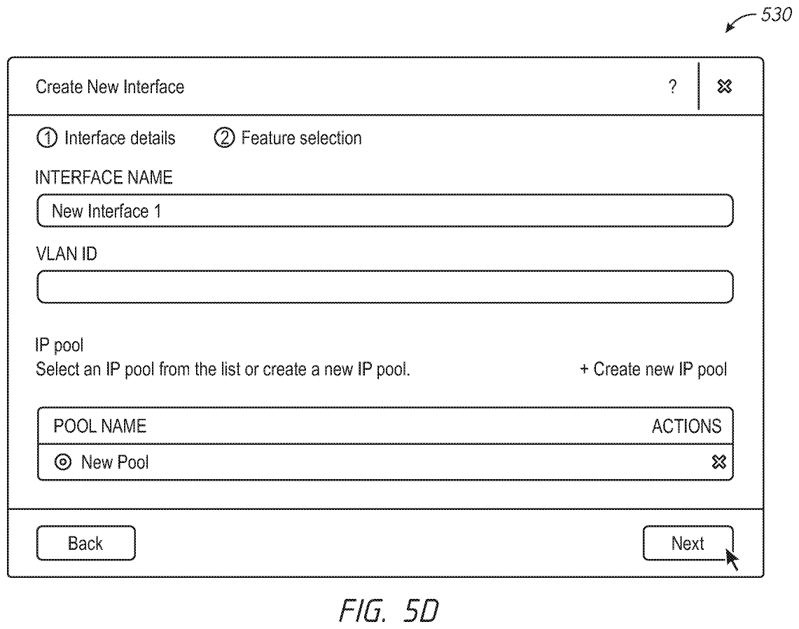

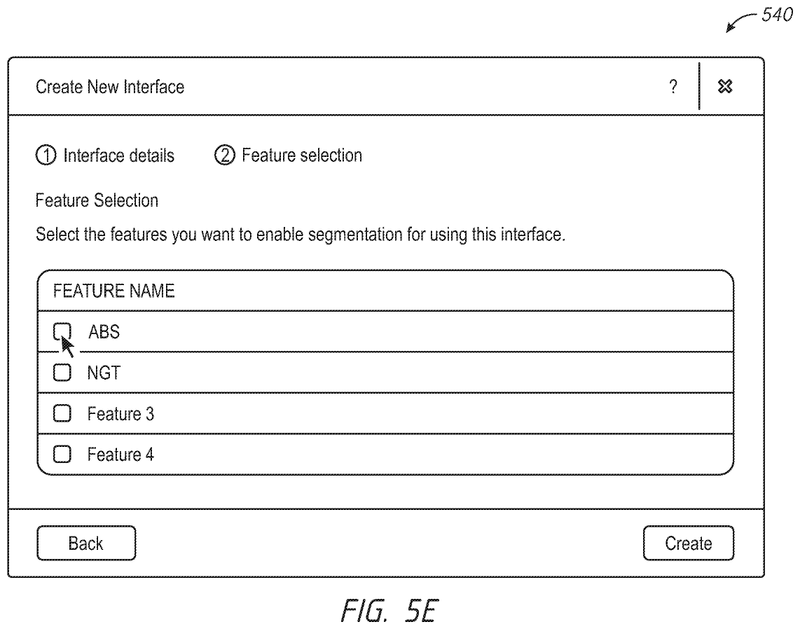

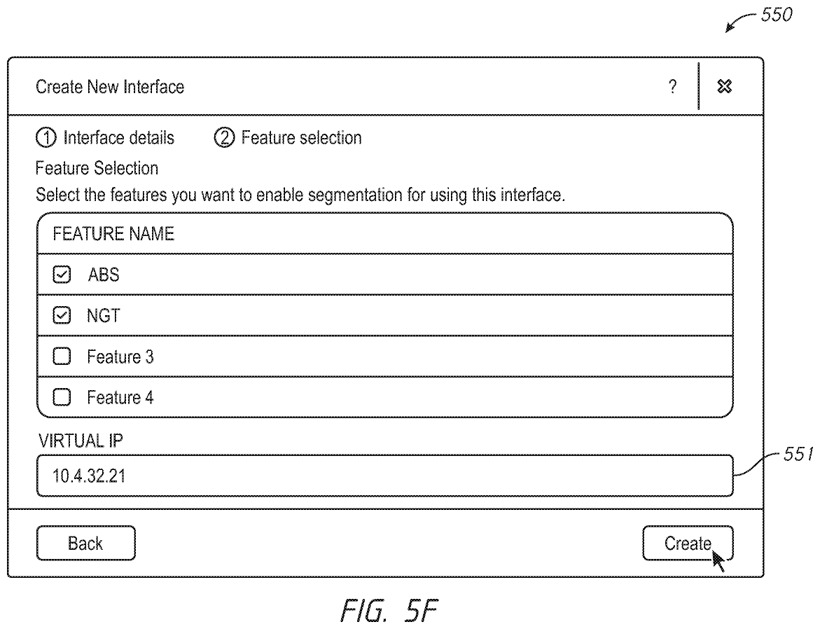

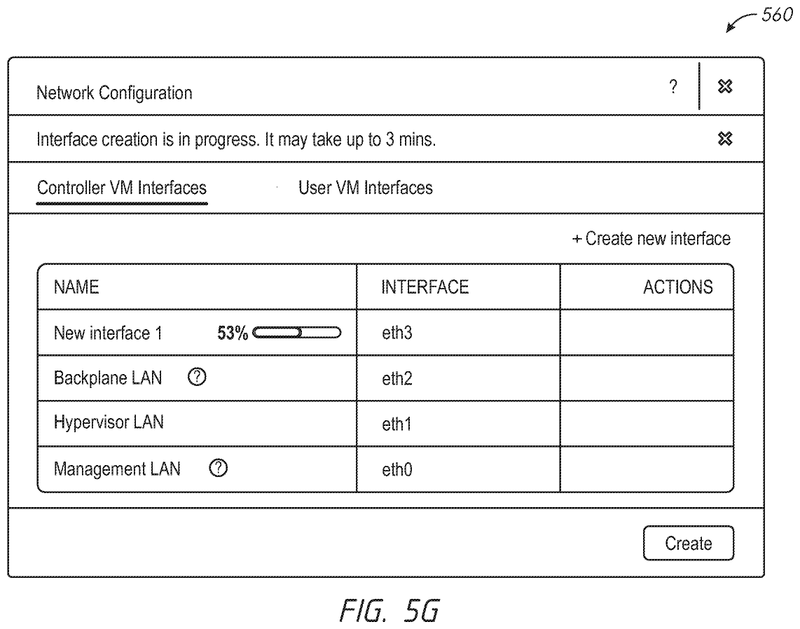

FIG. 4 is a flowchart of a method 400 for setting up a network segmentation interface for a distributed computing system in accordance with some embodiments of the disclosure. FIGS. 5A-G include example user interface diagrams for setting up a network segmentation interface for a distributed computing system in accordance with some embodiments of the disclosure. The method 400 may be performed by an administrator system, such as the administrator system 158 of FIG. 1.

The method 400 may include initiating a user interface to create a new network segmentation interface associated with a class of data traffic, at 410. The diagram 500 of FIG. 5A provides an example of a user interface for creating a new network segmentation interface. The new network segmentation interface (e.g., one of ETH0-2) may include allocating a specific class of traffic to a new network interface.

The method 400 may include adding selected details associated with the new network interface in response to received input, at 412. The diagram 510 of FIG. 5B provides an example a user interface for adding network interface details. The new network segmentation interface details may include a new network interface name, an identifier for the corresponding vLAN (vLAN Identifier), and an IP address pool. The IP address pool identifies a pool of IP addresses that may be used for the new network interface. In some examples, portions of the user interface may be disable in response to missing required information. For example, the “Next” button 511 may be disabled until an IP address pool is created or assigned to the new network interface, in some examples.

In some examples, the method 400 may include creating a new IP address pool, at 420. Creating the new IP address pool may include adding IP pool details, at 422. The diagram 520 of FIG. 5C provides an example of a user interface for creating a new IP address pool and adding IP pool details. The IP pool details may include a pool name, a netmask, and a range of IP addresses. In some examples, an existing IP pool may be used.

The method 400 may include selecting an IP address pool, at 430. The selected IP address pool may include an existing IP address pool, or a newly created IP address pool from steps 420 and 422. In some examples, the selection of the IP address pool may be automatic if only a single IP address pool exists in a selection list. The diagram 540 of FIG. 5D provides an example of the interface for creating the new network segmentation interface with the IP pool automatically selected.

The method 400 may include selecting additional features for the new network interface, at 440. The diagram 540 of FIG. 5E provides an example of an interface for selecting additional features. The additional features/options may include block services, guest tools, or other features.

The method 400 may include creating the new network interface, at 450. The diagram 540 of FIG. 5E provides an example of a user interface for selecting additional features. The additional features/options may include block services, guest tools, or other features. If certain features are selected, the user interface may update to request additional information. For example, the diagram 550 of FIG. 5F provides an example of an update to the user interface shown in the diagram 540 of FIG. 5E to include an entry 561 for a virtual IP address in response to selection of at least one of the block services or guest tools features. The diagram 560 of FIG. 5G provides an example of an interface for tracking progress of creation of the new network interface.

The method 400 may include determining whether creation of the new network interface is successful, at 460. In response to a determination that creation of the new network interface was successful, the method 400 may further include providing a successful creation indication, at 470. Determining whether creation of the new network interface was successful may be based on a notification of successful creation, appearance of the network interface as an option, lack of an error message in creation of the network interface, etc. In response to a determination that creation of the new network interface failed, the method 400 may further include providing a creation failed indication, at 480. The failure may be caused by lack of necessary information, such as failure to select an IP pool or selection of an IP pool that is already in use for the system, selection of incompatible features, etc. The diagram 540 of FIG. 5E provides an example of an interface for selecting additional features. The additional features/options may include block services, guest tools, or other features.

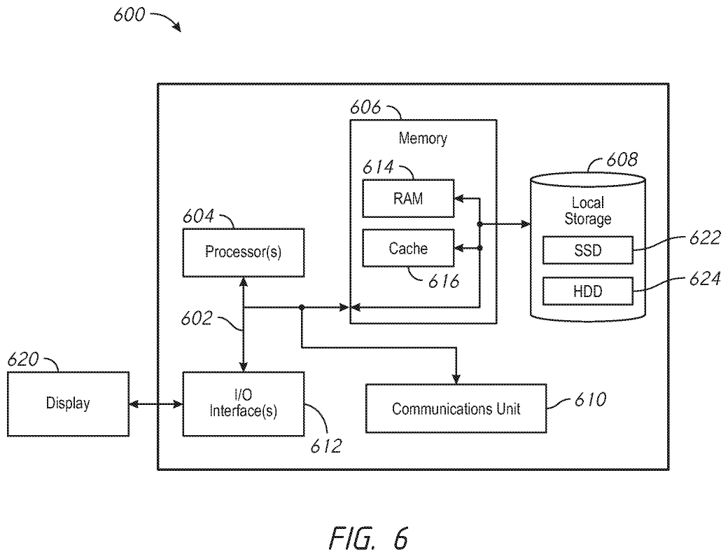

FIG. 6 depicts a block diagram of components of a computing node 600 in accordance with an embodiment of the present disclosure. It should be appreciated that FIG. 6 provides only an illustration of one implementation and does not imply any limitations with regard to the environments in which different embodiments may be implemented. Many modifications to the depicted environment may be made. The computing node 600 may implemented as the administrator system 158, the computing node 102, and/or the computing node 112 of FIG. 1, the computing node 202 and/or the computing node 212 of FIG. 2, or any combinations thereof. The computing node 600 may be configured to implement the methods 300 and 400 described with reference to FIGS. 3 and 4, respectively, in some examples, to migrate data associated with a service running on any VM.

The computing node 600 includes a communications fabric 602, which provides communications between one or more processor(s) 604, memory 606, local storage 608, communications unit 610, I/O interface(s) 612. The communications fabric 602 can be implemented with any architecture designed for passing data and/or control information between processors (such as microprocessors, communications and network processors, etc.), system memory, peripheral devices, and any other hardware components within a system. For example, the communications fabric 602 can be implemented with one or more buses.

The memory 606 and the local storage 608 are computer-readable storage media. In this embodiment, the memory 606 includes random access memory RAM 614 and cache 616. In general, the memory 606 can include any suitable volatile or non-volatile computer-readable storage media. The local storage 608 may be implemented as described above with respect to local storage 124 and/or local storage 130. In this embodiment, the local storage 608 includes an SSD 622 and an HDD 624, which may be implemented as described above with respect to SSD 126, SSD 132 and HDD 128, HDD 134 respectively.

Various computer instructions, programs, files, images, etc. may be stored in local storage 608 for execution by one or more of the respective processor(s) 604 via one or more memories of memory 606. In some examples, local storage 608 includes a magnetic HDD 624. Alternatively, or in addition to a magnetic hard disk drive, local storage 608 can include the SSD 622, a semiconductor storage device, a read-only memory (ROM), an erasable programmable read-only memory (EPROM), a flash memory, or any other computer-readable storage media that is capable of storing program instructions or digital information.

The media used by local storage 608 may also be removable. For example, a removable hard drive may be used for local storage 608. Other examples include optical and magnetic disks, thumb drives, and smart cards that are inserted into a drive for transfer onto another computer-readable storage medium that is also part of local storage 608.

Communications unit 610, in these examples, provides for communications with other data processing systems or devices. In these examples, communications unit 610 includes one or more network interface cards. Communications unit 610 may provide communications through the use of either or both physical and wireless communications links.

I/O interface(s) 612 allows for input and output of data with other devices that may be connected to computing node 600. For example, I/O interface(s) 612 may provide a connection to external device(s) 618 such as a keyboard, a keypad, a touch screen, and/or some other suitable input device. External device(s) 618 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 608 via interface(s) 612. 1/0 interface(s) 612 also connect to a display 620.

Display 620 provides a mechanism to display data to a user and may be, for example, a computer monitor.

What is claimed is:

1. A method comprising:
receiving a network segmentation request at a distributed computing system;
in response to the network segmentation request and during normal operation of the distributed computing system:
allocating and assigning a plurality of internet protocol (IP) addresses to computing nodes of the distributed computing system based on a number of segmented networks defined in the network segmentation request; and
applying firewall rules to open a plurality of service ports of the computing nodes;
updating network configuration information of the computing node;
for a computing node of the computing nodes of the distributed system:
publishing the respective IP address of the allocated and assigned plurality of IP addresses associated with the computing node; and
restarting services of the computing node; and
applying the firewall rules to open a subset of the plurality of service ports of the computing node.

2. The method of claim 1, further comprising, restarting services of the computing node, for a second computing node of the computing nodes:
publishing the respective IP address of the allocated and assigned plurality of IP addresses associated with the second computing node; and
restarting services of the second computing node.

3. The method of claim 1, wherein applying the firewall rules to open the subset of the plurality of service ports of the computing nodes comprises opening service ports associated with traffic internal to the distributed computing system.

4. The method of claim 1, further comprising receiving the network segmentation request comprises receiving a request to assign a first class of data traffic to a first network interface and a request to assign a second class of data traffic to a second network interface.

5. The method of claim 4, wherein the first class of data traffic is internal to the distributed computing system and the second class of data traffic includes data traffic that is external to the distributed computing system.

6. The method of claim 4, wherein the first network interface include parameters pertaining to one or more of the firewall rules, subnets, network masks, virtual networks identifiers, IP address pools and ranges, service port numbers.

7. The method of claim 1, wherein restarting the services of the computing node comprises:
stopping the services from running;
updating IP addresses based on the allocated and assigned plurality of IP addresses, and rebooting the services of the computing node.

8. The method of claim 1, wherein updating the network configuration information of the computing node comprises identifying at least one of a new subnet, a network mask, or a virtual local area network (vLAN) identifier.

9. The method of claim 8, wherein updating the network configuration information of the computing nodes further comprises allocating the respective allocated and assigned plurality of IP addresses to a respective virtual network interface card (vNIC) based on the network segmentation request.

10. A computing node comprising:
at least one processor; and
memory storing instructions that, when executed by the at least one processor, cause the computing node to:
initiate a user interface to create a new network segmentation interface associated with a class of data traffic;
add selected details associated with the new network interface in response to received input, wherein the selected details include at least one of a new network interface name, an identifier for a corresponding virtual local area network (vLAN), or an IP address pool;
after addition of the selected details, create the new network interface in response to a request; and
provide confirmation of creation of the new network interface.

11. The computing node of claim 10, wherein the instructions further cause the computing node to:
determine whether creation of the new network interface was successful;
in response to a determination that creation of the new network interface failed, provide a creation failed indication.

12. The computing node of claim 11, wherein the instructions further cause the computing node to, in response to a determination that creation of the new network interface was successful, provide a successful creation indication.

13. The computing node of claim 10, wherein the instructions further cause the computing node to:
create a new IP address pool in response to user selections; and
add the new IP address pool to the selected details.

14. The computing node of claim 10, wherein the instructions further cause the computing node to create the new IP address pool and add details to the new IP address pool including at least one of a pool name, a netmask, or a range of IP addresses.

15. The computing node of claim 10, wherein the instruction that cause the computing node to disable portions of the user interface in response to missing required information.

16. The computing node of claim 10, wherein the instruction that cause the computing node to provide an indication of progress during creation of the new network interface on the user interface.

17. A computing system comprising:
a plurality of computing nodes, wherein, during normal operation, a first computing node of the plurality of computing nodes is configured to receive a network segmentation request at a distributed computing system, and in response to the network segmentation request, the first computing node is configured to create a new network interface and transition to using the new network interface during the normal operation.

18. The computing system of claim 17, wherein the first computing node configured transition to the new network interface comprises:
allocation and assignment of an internet protocol (IP) address;
application of firewall rules to open a plurality of service ports associated with the new network interface and an existing network interface;
performance of an update network configuration information;
publishing the allocated and assigned IP address;
performance of a restart of running services; and
application of the firewall rules to the plurality of service ports associated with the new network interface.

19. The computing system of claim 18, wherein the new network interface corresponds to traffic internal to the plurality of computing nodes.

20. The computing system of claim 19, wherein the existing network interface includes traffic external to the plurality of computing nodes.
